(19) United States
(12) Patent Application Publication
(10) Pub. No.: US 2014/0307451 A1
(43) Pub. Date: Oct. 16, 2014

(54) OUTDOOR LED LIGHTING DEVICE STRUCTURE WITH GOOD CHARACTERISTICS OF THERMAL DISSIPATION AND WATERPROOF

(71) Applicant: Ming-Yuan WU, Tiapei (TW)

(72) Inventor: Ming-Yuan WU, Tiapei (TW)

(21) Appl. No.: 13/910,239

(22) Filed: Jun. 5, 2013

(30) Foreign Application Priority Data
Apr. 10, 2013 (TW) 102112621

(51) Int. Cl. F21V 15/01

(52) U.S. Cl. CPC F21V 15/011
USPC 362/373

(57) ABSTRACT

An outdoor LED lighting device includes a casing, a light emitting module, a driver module and a connecting module. This LED lighting device may be installed in a housing of the conventional outdoor lamp without having to discard the whole set of the conventional outdoor lamp, thus eliminating the unnecessary waste, in achieving cost-effectiveness and environment protection. Also, the LED lighting device has good characteristics of thermal dissipation and waterproof. Moreover, the light materials may be utilized to reduce the weight of the lighting device. The LED lighting device may be easy to install the street light and replace the conventional bulbs.

### BACKGROUND OF THE INVENTION

1. Field of Invention

The present invention relates to a light-emitting diode (LED) lamp and a street lamp using the same, and, more particularly, but not exclusively to an outdoor LED lighting device structure with good characteristics of thermal dissipation and waterproof.

2. Related Art

As a solid state light source, LEDs (light-emitting diodes) are a product with long life span, firm structure, low power consumption and flexible dimension such that they are becoming to take the place of conventional high pressure halide lamps in a wide range of lighting applications. However, LEDs would generate comparatively high heat energy, with a result of their high light fades and shortened life span. This leads to limited applications of LEDs to some extent.

Legacy street lighting systems are based on high pressure discharge lamps, most commonly high pressure sodium (HPS) lamps. These have been generally recognized to give the highest amount of lighting per watt of electricity used. New street lighting technologies, such as Light Emitting Diode (LED) and Induction lighting, emit a white light that provides high levels of scotopic lumens allowing street lights with lower wattages and lower photopic lumens to replace existing street lights.

When the outdoor lamp is exposed to outside for a long period of time, the fixing screws may be gradually eroded. Thus, rain or snow may creep through clearances between the screws and the housing of the outdoor lamp, and enter into the housing to thereby cause electrical short circuit and potential safety problems. Also, when the LED lamp is lightened over a long period of time, the heat generated by the LED would accumulate in the LED lamp and could not be effectively removed therefrom, bringing the LED to burn out due to overheat.

Presently, great efforts have been made to provide various solutions in an attempt to tackle the heat dissipation of the LED lighting fixtures. However, these solutions are either less effective to dissipate the heat, or are expensive and structurally complicated though being effective on heat dissipation. Therefore, replacement of conventional street lamps with LED lamps requires both improving their thermal dissipation with low costs and providing an improved waterproof structure that can be used outdoors for longer periods of time with improved durability and high safety.

### SUMMARY OF THE INVENTION

The present invention overcomes the above-described and other problems and disadvantages in the prior art by providing an outdoor LED light device to easily replace the conventional outdoor lamps, such as garden lights, path lights, street lights, wall lights or the like.

An object of the present invention is to provide a heat dissipation mechanism and a waterproof structure for outdoor LED lighting device to achieve excellent heat dissipation and waterproof effects with cost down.

It is another objective of the present invention to provide the outdoor LED light device with simplified structure. The plastic materials may be used for the lamp holder to reduce the material costs.

Accordingly, the present invention provides an outdoor LED(light emitting diode) lighting device including a casing, a light emitting module, a driver module and a connecting module. A hollow space is provided in the casing. The light emitting module is detachably disposed in the hollow space of the casing and contacted to a radiator disposed therein. The driver module is detachably disposed in the casing and adjacent to the light emitting module. The connecting module is disposed on the casing and electrically connected to the driver module and a connecting base. Therefore, the LED lighting device may be installed in a housing of the conventional outdoor lamp without having to discard the whole set of the conventional outdoor lamp, thus eliminating the unnecessary waste, in achieving cost-effectiveness and environment protection.

Also, the LED lighting device has good characteristics of thermal dissipation and waterproof. Moreover, the light materials may be utilized to reduce the weight of the lighting device. The LED lighting device may be easy to install the street light and replace the conventional bulbs.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow illustration only, and thus are not limitative of the present invention, and wherein:

FIGS. 1A, 1B and 1C are perspective views of the outdoor LED lighting device of a first preferred embodiment of the present invention;

FIGS. 2A and 2B are schematic views of the outdoor LED lighting device of another preferred embodiment of FIG. 1A;

FIGS. 3A and 3B are exploded views of the outdoor LED lighting device of FIG. 2A;

FIG. 4 is a exploded view of the outdoor LED lighting device of a second preferred embodiment of the present invention;

FIG. 5 is a perspective view of the outdoor LED lighting device of FIG. 4;

FIG. 6 is a perspective view of the outdoor LED lighting device of FIG. 4;

FIG. 7 is a side view of the outdoor LED lighting device of FIG. 4;

FIGS. 8A, 8B and 8C are schematic views of the outdoor LED lighting device of another preferred embodiment of the present invention;

FIG. 9 is perspective view of the outdoor LED lighting device of a third preferred embodiment of the present invention;

FIGS. 10A and 10B are schematic views of the outdoor LED lighting device of another preferred embodiment of FIG. 9; and

FIGS. 11A and 11B are perspective views of the outdoor LED lighting device of a forth preferred embodiment of the present invention.

### DETAILED DESCRIPTION OF THE INVENTION

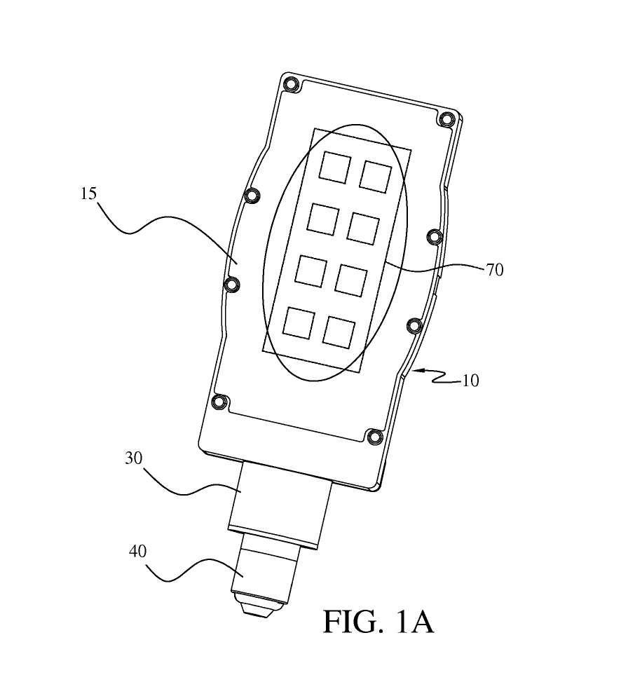

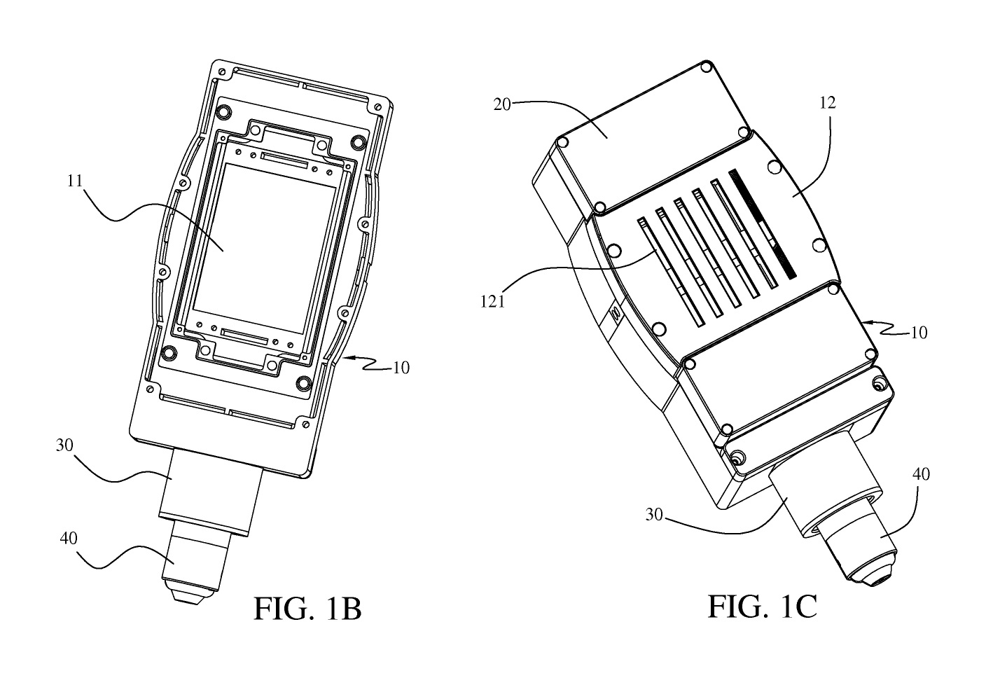

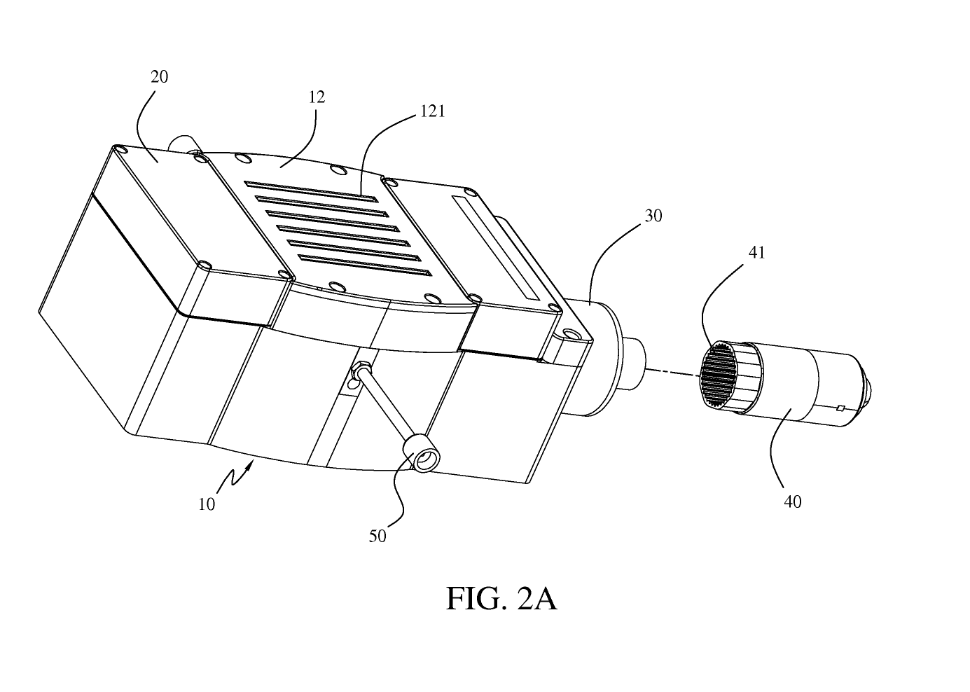

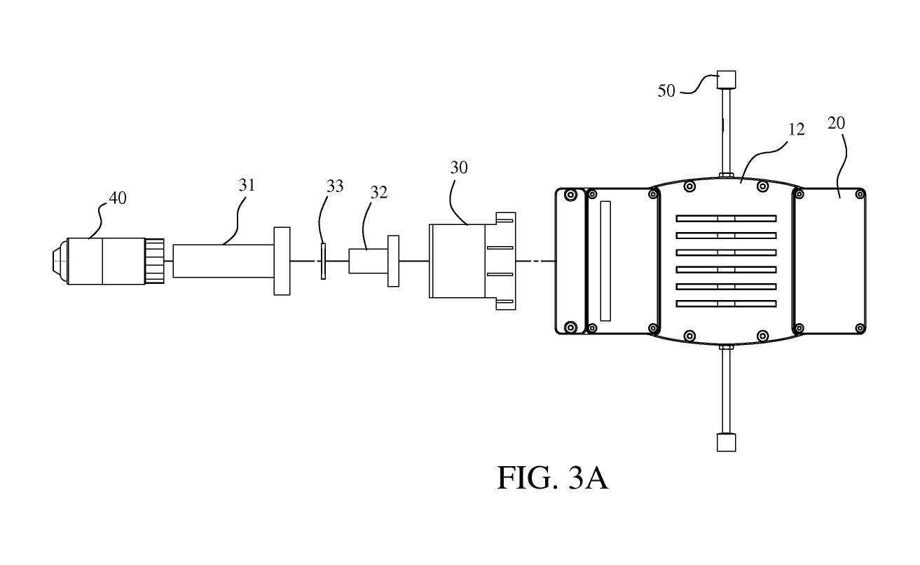

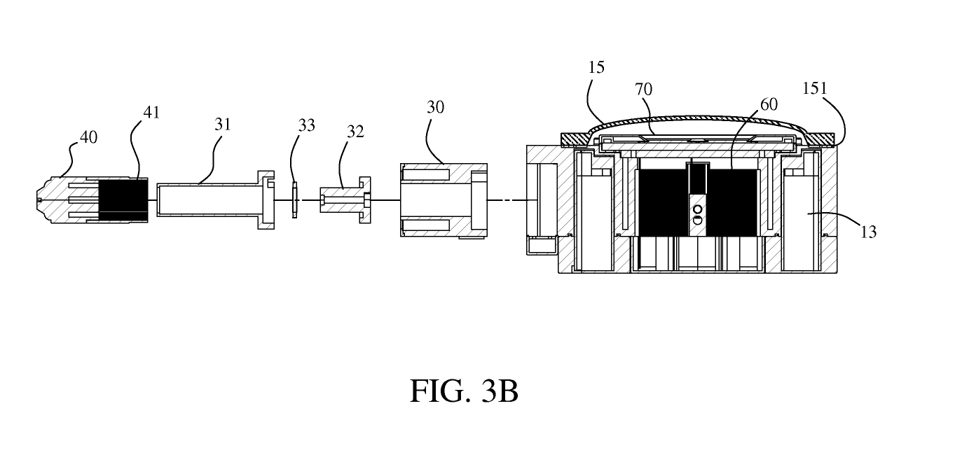

An outdoor LED (light emitting diode) lighting device of a first embodiment of the present invention is shown in FIGS. 1A, 1B to 1C. The outdoor LED lighting device including a casing 10, a light emitting module 70, a driver module 20 and a connecting module 30. A hollow space 11 is provided in the casing 10. The light emitting module 70 is detachably disposed in the hollow space 11 of the casing 10 and contacted to a radiator 60 disposed therein, also see FIG. 3B. The driver module 20 is detachably disposed in the casing 10 and adjacent to the light emitting module 70. The connecting module 30 is disposed on the casing 10 and electrically connected to the driver module 20 and a connecting base 40 of the the conventional outdoor lamp to replace the conventional bulbs. The connecting module 30 may be detachable and changeable with different type to connect to the connecting base 40, such as screw type or plug type. As shown in FIG. 1A, the connecting module 30 and the connecting base 40 are plug type. Therefore, the LED lighting device may be installed in a housing of the conventional outdoor lamp without having to discard the whole set of the conventional outdoor lamp, thus eliminating the unnecessary waste, in achieving cost-effectiveness and environment protection.

A lamp cover 15 is disposed on the top of the casing 10 to protect the light emitting module 70. The waterproof element 151 is disposed between the casing 10 and the lamp cover 15. The waterproof element 151 includes a waterproof pad, a waterproof ring, a waterproof glue and etc. Also, the waterproof glue may be applied to connection section of the connecting base 40 and the connecting module 30 to ensure waterproof performance.

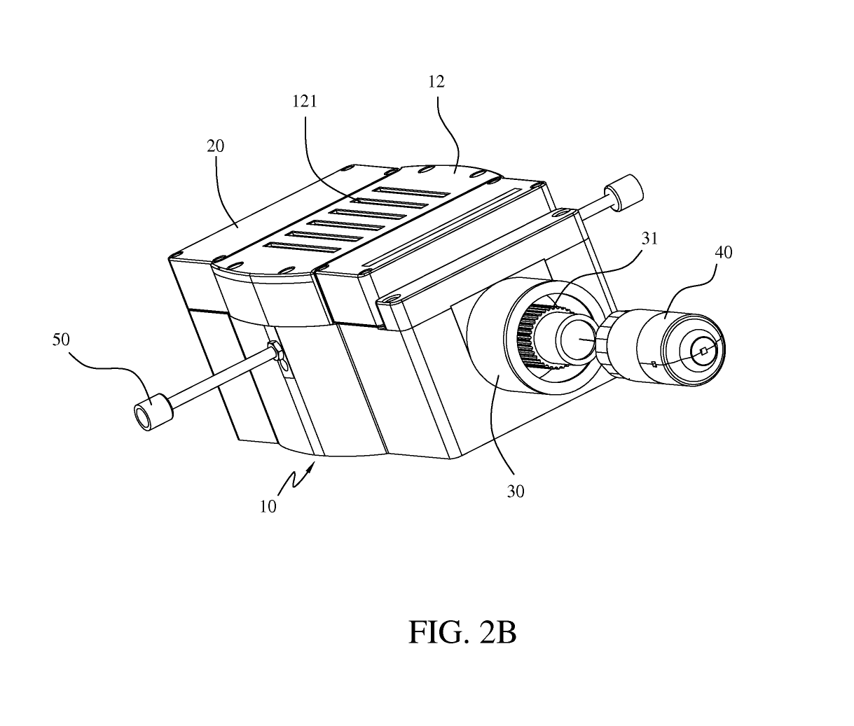

Please refer to FIGS. 2A and 2B, the casing 10 may further include two supporters 50 located at two side walls. The supports 50 are used to support and fix the outdoor LED lighting device in the housing of the conventional outdoor lamp. Moreover, a heat generated by the light emitting module 70 may be dissipated to the housing through the supports 50. A back cover 12 is disposed on the casing 10, and at lease one heat dissipating hole 121 is provided in the back cover 12. The heat dissipating hole 121 may quickly dissipate the heat generated by the light emitting module 70 to avoid overheating.

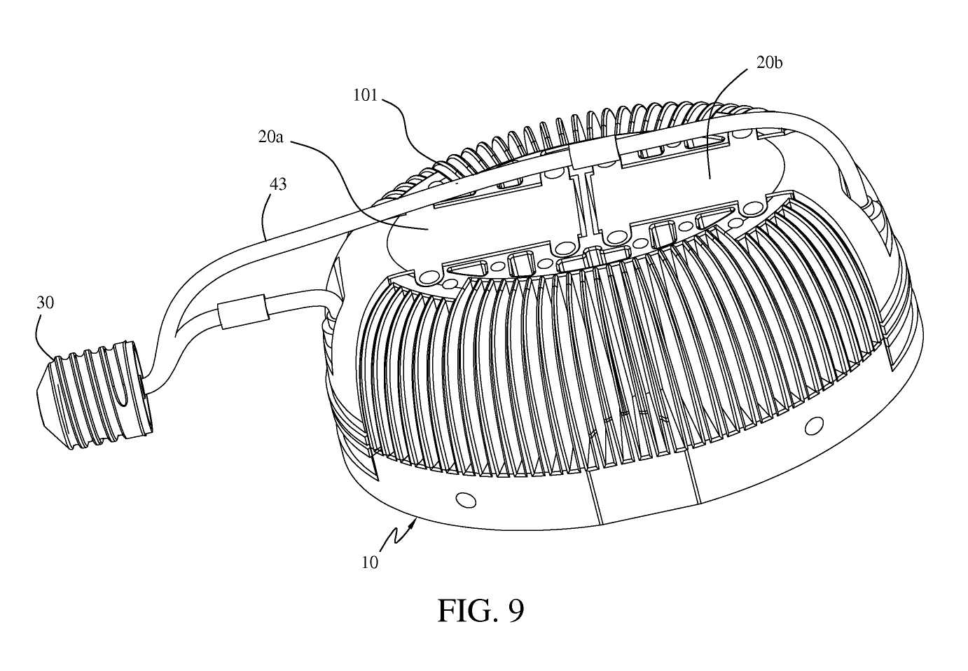

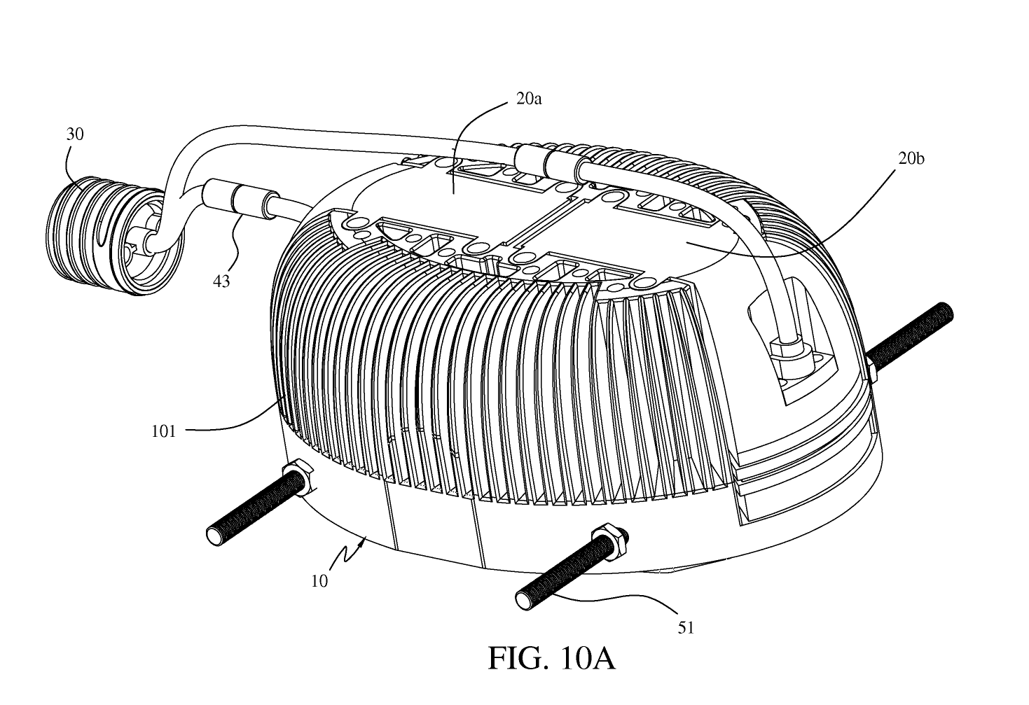

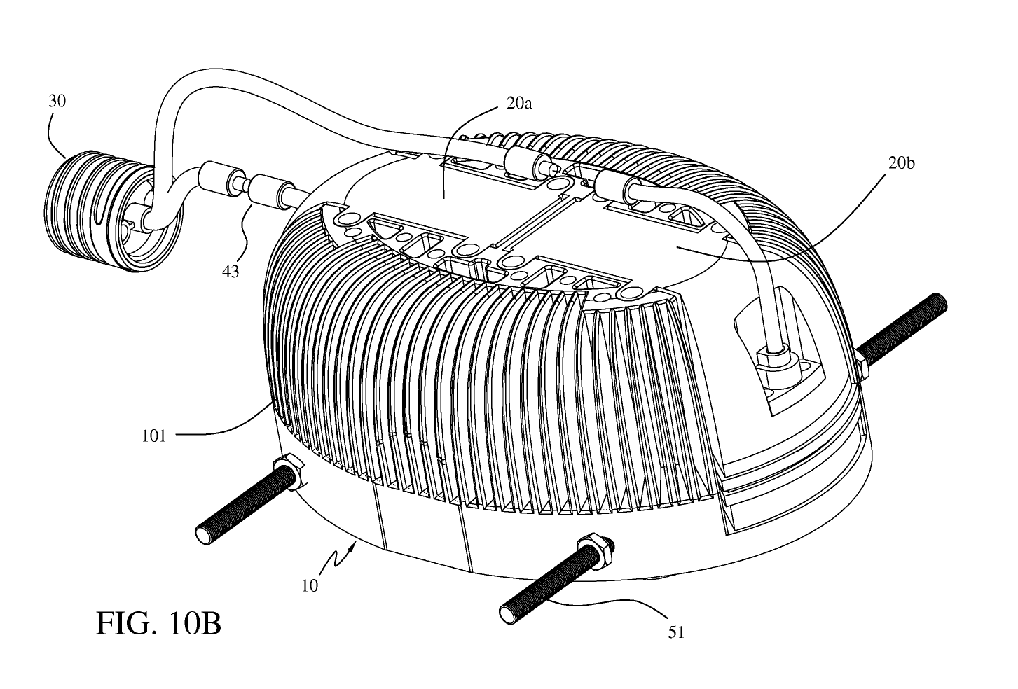

Please also refer to FIGS. 3A and 3B, the connecting module 30 includes a connecting end 31 and a collector ring 32. The connecting end 31 has a sawtooth-like outer surface to be physically connected to the connecting base 40. The connecting base 40 also includes a sawtooth-like inner surface 41 to be physically connected with the sawtooth-like outer surface of the connecting end 31. The collector ring 32 is electrically connected to the driver module 20 and the connecting base 40. The connecting base 40 is rotatable with respect to the connecting module 30 and maintains the electrical connection by the collector ring 32. Therefore, the outdoor LED lighting device whose angle may be adjusted according the actual need. Also, the waterproof element 33 is disposed between the connecting module 30 and the connecting base 40. The waterproof element 33 includes a waterproof pad, a waterproof ring, a waterproof glue and etc. Furthermore, the connecting module 30 may be electrically connected to the driver modules 20a, 20b by a waterproof cable joint 43, see FIGS. 9, 10A and 10B. As shown in FIG. 9, the connecting module 30 is screw type. Moreover, the screw type supporters 51 are used to support and fix the outdoor LED lighting device in the housing of the conventional outdoor lamp.

The casing 10 includes at least one side hollow space 13 to store the driver module 20. The driver module 20 is configured to receive input power from an AC power source such as a commercial power source or from a DC power source such as a battery, to convert the input power into required DC power, and output the required DC power to the light emitting module 70. The driver module 20 may also be adapted to control or regulate the total current for the light emitting module 70. The number of the driver module 20 may be varied according to the need. As shown in FIG. 3B, two driver modules 20 are disposed.

The driver module 20 is modular structure to enable rapid repair and maintenance. Also, the driver module 20 may be designed to a waterproof structure. Therefore, the outdoor LED lighting device may be used as a street light alone without being disposed the conventional housing. Due to the whole outdoor LED lighting device has excellent waterproof effect, the outdoor LED lighting device still works well after being exposed to outside for a long period of time.

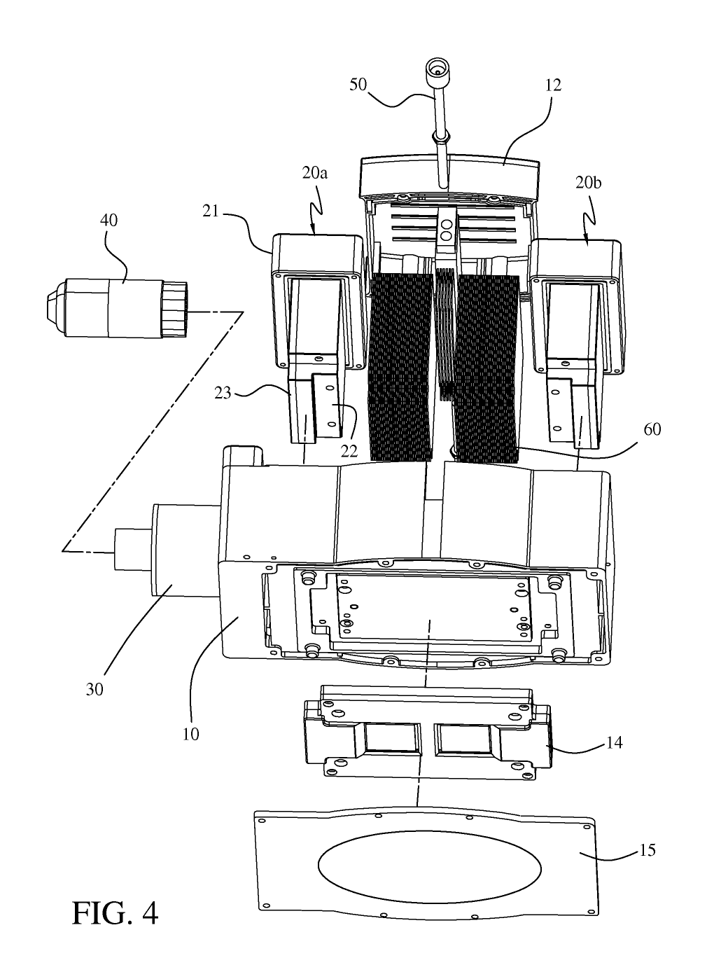

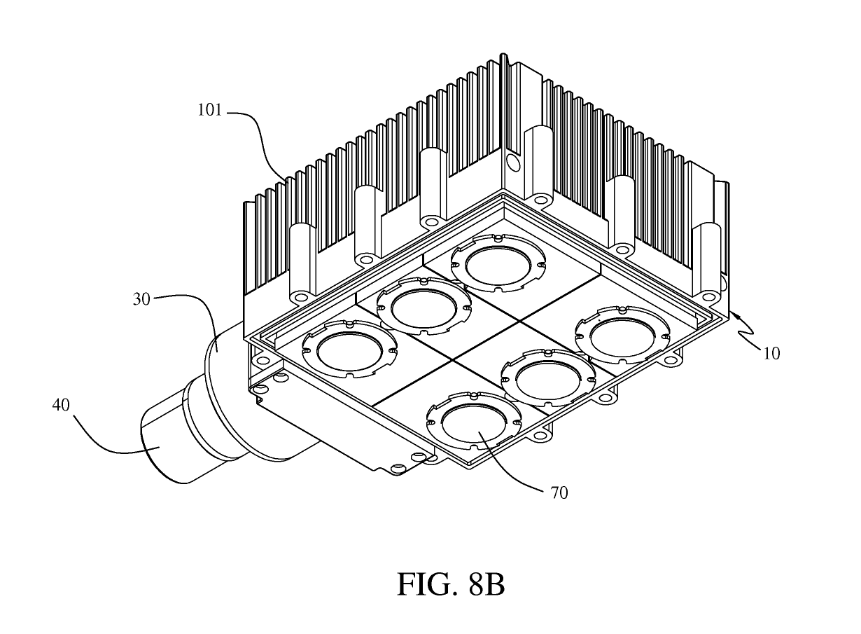

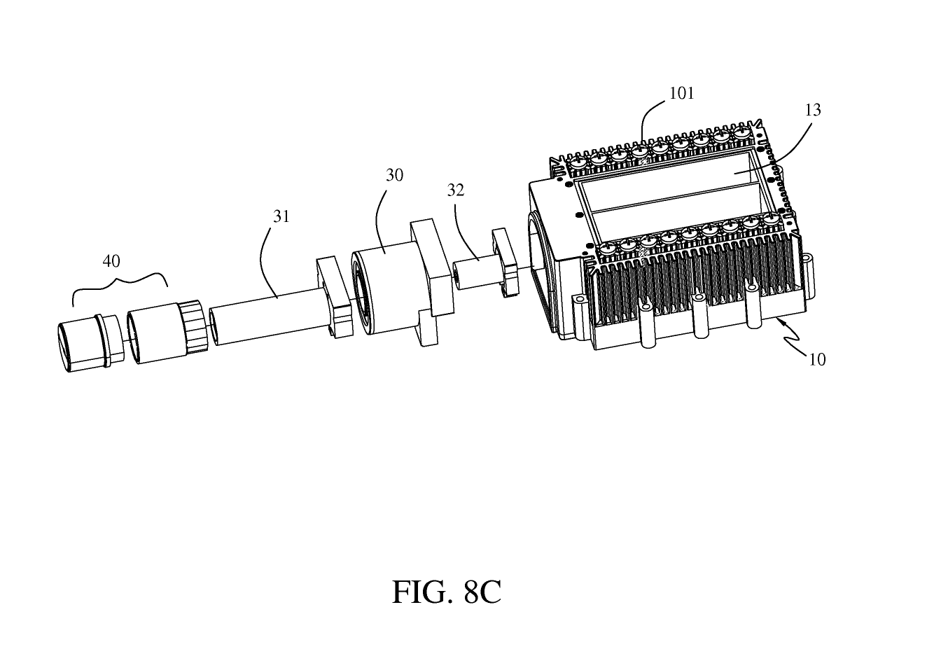

Please refer to FIG. 4, the radiator 60 is a fin type heat sink and disposed in the hollow space 11 of the casing 10. The radiator 60 may be formed by aluminum-alloy extruded material and disposed in the hollow space 11 by the thermal insulating pad with waterproof characteristic to give consideration to waterproof, heat dissipation and insulation. Please refer to FIGS. 8A and 8B, the outer surface of the casing 10 may further have an auxiliary fin type heat sink 101 to improve the heat dissipation effect.

The casing 10 may include a substrate 14 to connect the light emitting module 70. The driver modules 20a, 20b are composed of a driver cover 21, a driver shell 22 and a driver bottom 23.

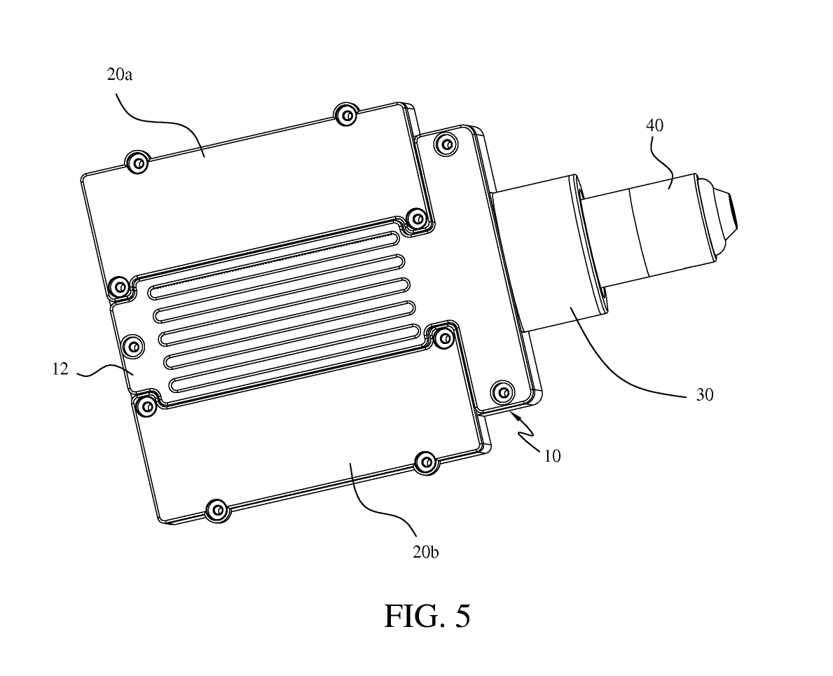

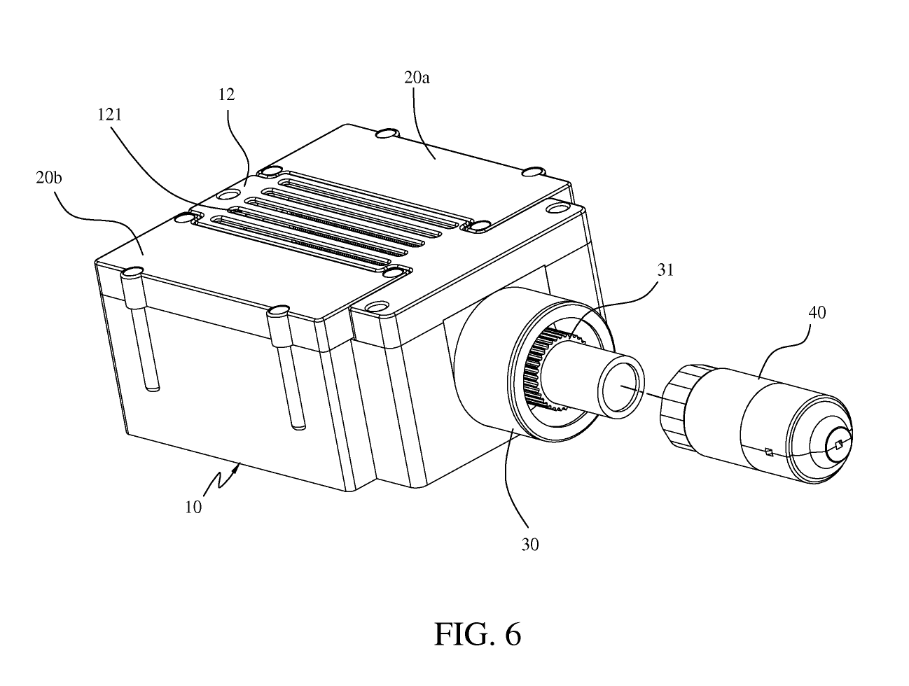

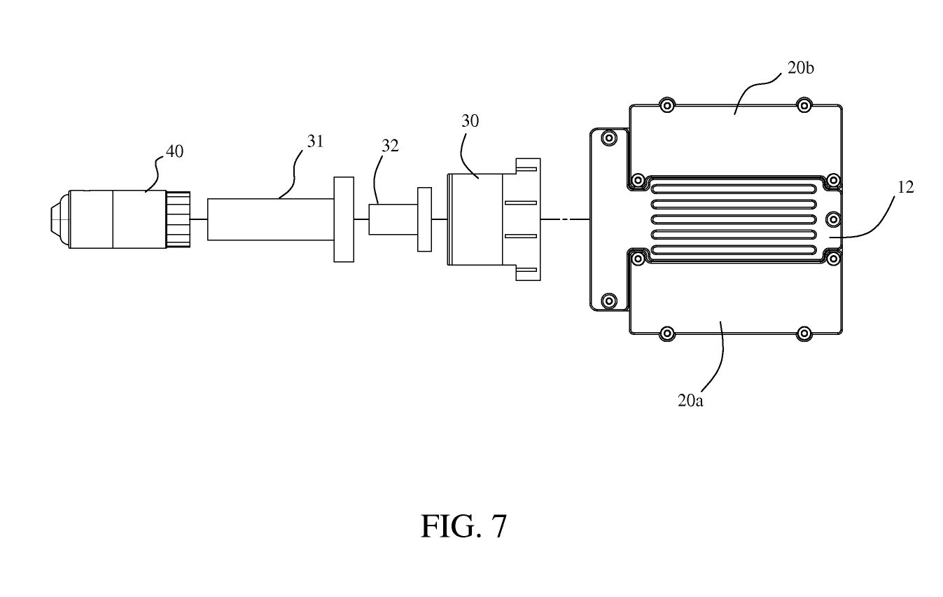

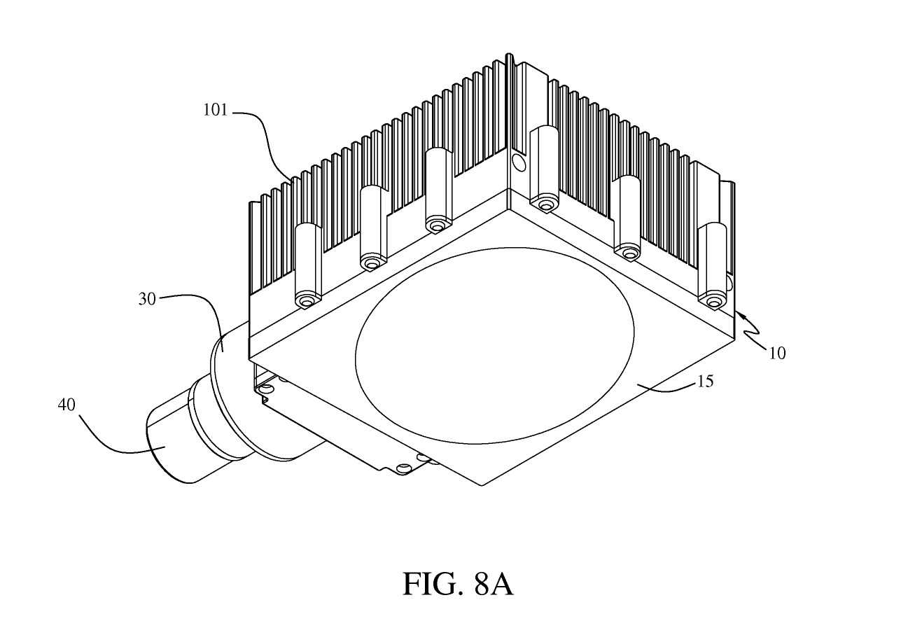

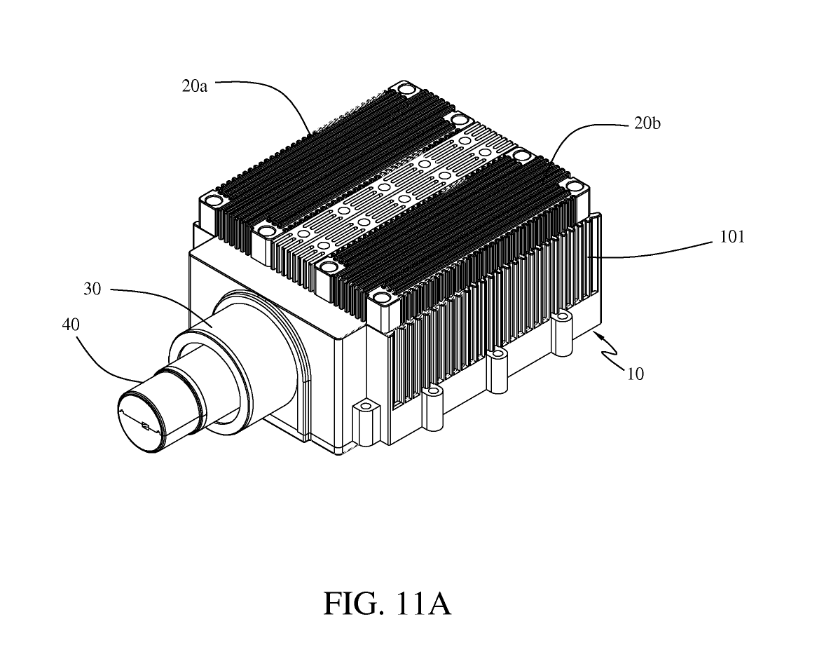

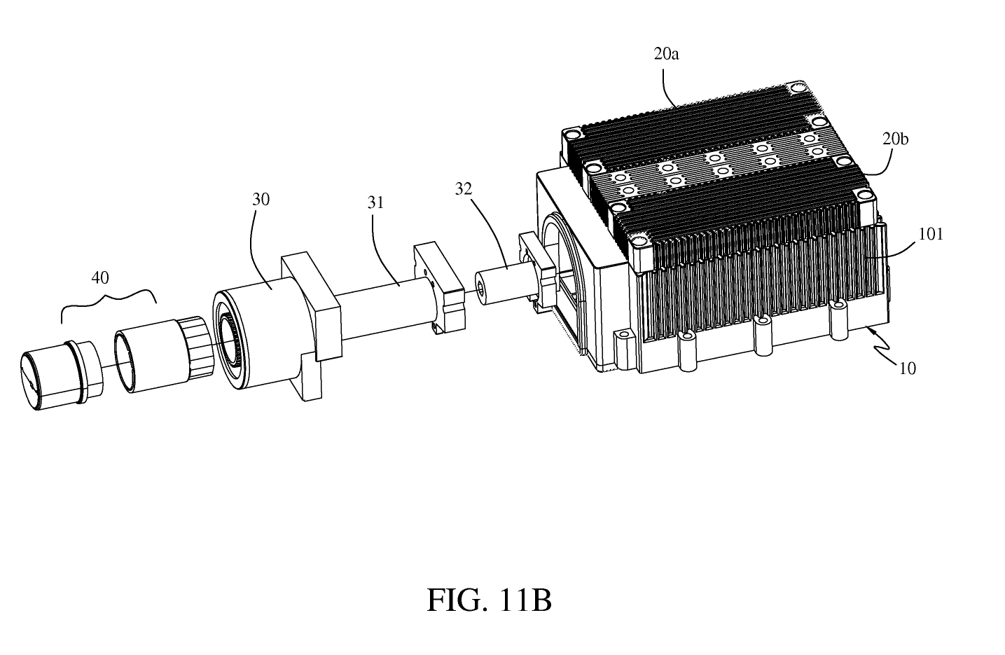

An outdoor LED lighting device of a second embodiment of the present invention is shown in FIGS. 5, 6 and 7. The driver modules 20a, 20b are disposed at different locations with respect to the first embodiment. In the condition of the input power is regulated, the driver modules 20a, 20b may be eliminated. Also, the shape of the casing 10 may be modified, such as square-shaped, see FIGS. 8A ,8B and 8C, or a oval-shaped, see FIGS. 9, 10A and 10B. Please refer to FIGS. 11A and 11B, the driver modules 20a, 20b may be located at two sides of the casing 10. Moreover, a single lens or lens set may be added between the cover 15 and the light emitting module 70 to make the emitted light be uniform. Alternative, the lens may be integrated into the cover 15 or the light emitting module 70.

Accordingly, the present invention provides an outdoor LED lighting device which has good characteristics of thermal dissipation and waterproof. The outdoor LED lighting device can also have a prolonged service life and decreased light fade. Also, the outdoor LED lighting device has simplified structure. The light materials, such as plastic or aluminum, may be used to reduce the material costs and to mass-produce easily. The modular design of the outdoor LED lighting device eases maintenance and tends to lower costs of maintenance as a failed light emitting module, or a driver module is easy to replace and is less expensive to replace than replacement of the entire lamp.

The outdoor LED lighting device may be installed in a housing of the conventional outdoor lamp without having to discard the whole set of the conventional outdoor lamp, thus eliminating the unnecessary waste, in achieving cost-effectiveness and environment protection. Also, the outdoor LED lighting device may be used as a street light alone without being disposed the conventional housing. The waterproof structure is applied in the driver module, between the connecting module and the connecting base, between the casing and the lamp cover, and between the connecting base and the lamp socket of the conventional outdoor lamp. The whole outdoor LED lighting device has excellent waterproof effect. Therefore, the outdoor LED lighting device still works well after being exposed to outside for a long period of time.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An outdoor LED (light emitting diode) lighting device, comprising:
a casing, wherein a hollow space is provided in the casing;
a light emitting module, detachably disposed in the hollow space of the casing and contacted to a radiator disposed therein;
a driver module, detachably disposed in the casing and being adjacent to the light emitting module; and
a connecting module, disposed on the casing and electrically connected to the driver module and a connecting base.

2. The outdoor LED lighting device of claim 1, wherein the connecting module comprising:
a connecting end, having a sawtooth-like outer surface to be physically connected to the connecting base; and
a collector ring, electrically connected to the driver module and the connecting base.

3. The outdoor LED lighting device of claim 2, wherein the connecting base includes a sawtooth-like inner surface to be physically connected with the sawtooth-like outer surface of the connecting end.

4. The outdoor LED lighting device of claim 2, wherein the connecting module is rotatable with respect to the connecting base and maintains the electrical connection by the collector ring.

5. The outdoor LED lighting device of claim 1, further comprising a waterproof element disposed between the connecting module and the connecting base, wherein the waterproof element includes a waterproof pad, a waterproof ring and a waterproof glue.

6. The outdoor LED lighting device of claim 1, wherein the connecting module is electrically connected to the connecting base by a waterproof cable joint.

7. The outdoor LED lighting device of claim 1, wherein the casing includes at least one supporter.

8. The outdoor LED lighting device of claim 1, wherein the radiator is a fin type heat sink.

9. The outdoor LED lighting device of claim 1, further comprising a back cover disposed on the casing, wherein at lease one heat dissipating hole is provided in the back cover.

10. The outdoor LED lighting device of claim 1, further comprising a lamp cover disposed on the casing to protect the light emitting module.

11. The outdoor LED lighting device of claim 10, further comprising a waterproof element disposed between the casing and the lamp cover, wherein the waterproof element includes a waterproof pad, a waterproof ring and a waterproof glue.
